(19) United States
(12) Patent Application Publication
(10) Pub. No.: US 2017/0353301 A1
(43) Pub. Date: Dec. 7, 2017

(54) Caravan

(71) Applicant: Jesse Burton Gregg, Shrewsbury, MA (US)

(72) Inventor: Jesse Burton Gregg, Shrewsbury, MA (US)

(21) Appl. No.: 15/169,731

(22) Filed: Jun. 1, 2016

(51) Int. Cl. H04L 9/06

(52) U.S. Cl. CPC H04L 9/0643

(57) ABSTRACT

A method for tracking relationships between binaries and their associated characteristics using a universal identifier applicable to innumerable verticals (eg. health care, manufacturing, IT, multimedia, genomics, etc.) and storing said universal identifier in a cryptographic currency block chain.

### FIELD

The invention is in the technical field of system administration and more particularly to the technical field of programmatic construction.

### BACKGROUND

Operating System-Level virtualization is often considered less secure and less flexible than more traditional hypervisor virtualization. The ease of duplication and modification of an existing binary creates the problem of insuring the binary to be used matches the original source.

### SUMMARY

Virtualization or programmatic construction technologies, any build process with a binary, such as, but not limited to, container technologies often include a facility to load components from a repository based on a predetermined specification or key. Caravan extends base functionality by providing a crypto currency block chain or like mechanism to store and verify the veracity of one unit or a linked chain of units and assure that said units adhere to the desired build components. Caravan utilizes a cryptographic hash stored within the binary and within the crypto currency block chain to insure decentralized and secure storage of needed keys.

Caravan includes an optional capability to insert instrumentation into the verified build for extended management capabilities.

### ADVANTAGES

1. Verification of links and link chains via an already proven verification technology mechanism
2. Simplifying detection of issues becomes simple when a developer knows where in a link chain a binary's integrity was violated
3. Audit capable to provide documentation or avoidance of known vulnerabilities
4. Independence from any single point of authority in the audit chain.
5. Ability to discover derived uses of a component independent of access to the internals of system
6. Ability to analyze components while preserving anonymity of the binary contents
7. Distributed and redundant storage of binary UIDs through leveraging OP_RETURN transactions in the desired cryptocurrency block-chain

### BRIEF DESCRIPTION OF THE DRAWINGS

FIG. 1 is a description of the creation of a universal identifier for a binary

FIG. 2 describes the process of associating a base binary component to its derived binary(s).

FIG. 3 describes the process for registering a root binary when it is not derived from any other binary(s).

FIG. 4 describes the creation of an audit tree, which is used for tracking relationships between binaries.

### DETAILED DESCRIPTION OF THE INVENTION

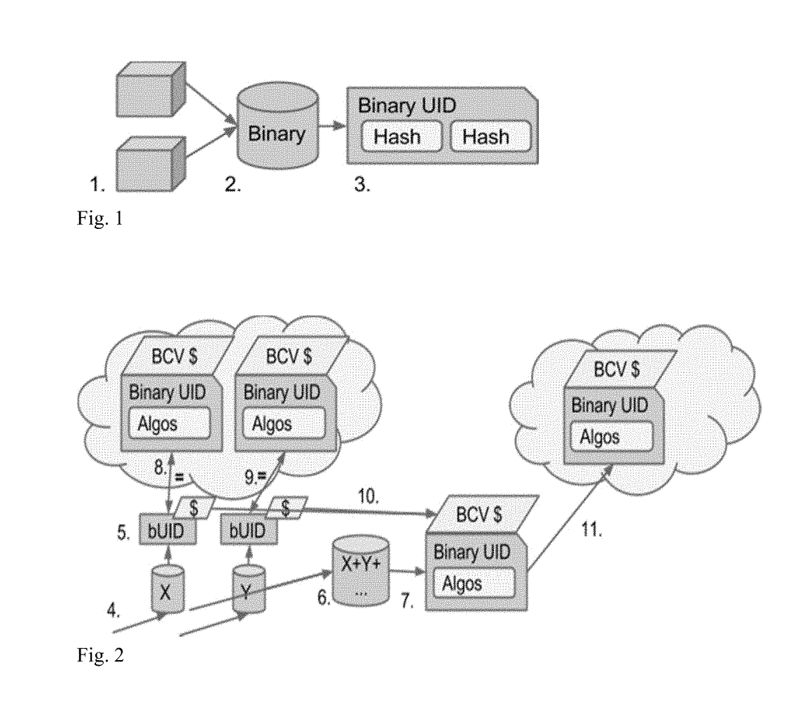

Actions involving the binary require a unique identifier, which we call the Binary UID or bUID for short. The process for creating the Binary UID is shown in FIG. 1. To create the binary UID, we (1) establish the baseline configuration using any build or assembly tool. (2) The components are combined into a single binary package. (3) One or more cryptographic algorithms are using to create the universal identifier for the binary.

FIG. 2 describes the process of associating a base binary to its derived binary components.

(4) The binary component(s) are acquired from any source. (5) The binary UID for is created for each component binary as described in FIG. 1. (6) The components are combined into a new binary, and then (7) a new Binary UID is created for this binary as explained in FIG. 1. (8) Acquire binary component(s) UID from repository/block-chain by OP_RETURN transaction for the download action to the repository for a fixed percentage of the current Binary Currency Value (BCV). (9) Verify source binary(s) produce correct UID(s) by comparing to the downloaded Binary UIDs to ensure a match. (10) Combine currency values to set BCV on the new Binary UID. (11) Broadcast the transaction using the Binary UIDs as the owner. If UID exists, BCV is combined such that every build chain is marked. Binary UID then uploaded to repository/block-chain.

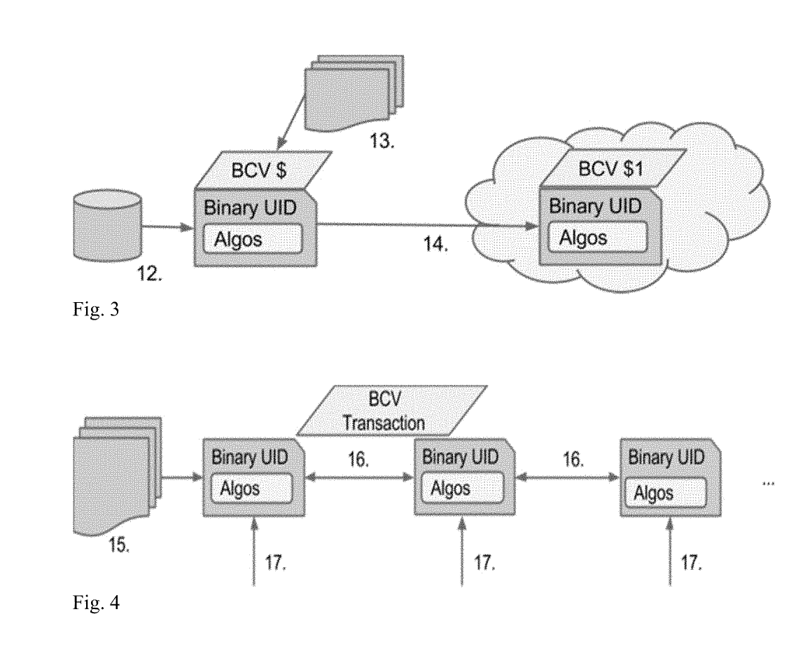

FIG. 3 describes the process for registering a binary that is not derived from any other binary.

(12) Create Binary Universal Identifier (UID) as in FIG. 1. (13) Query block-chain for matching Binary UID. If exists, use that Binary Currency Value (BCV). No broadcast required. (14) If not found, Broadcast Binary UID with BCV with an arbitrary BCV into block-chain.

FIG. 4 describes the process of creating the audit tree for tracking relationships between binaries. (15) Read the block-chain to get the Binary UIDs. (16) For each Binary UID, create a node in a tree for each transaction involving the Binary UID. (17) Create an index for quick lookup of a particular UID.

What is claimed is:

1. A method comprising:
generating an independent cryptographic hash of a binary process (binary A) with the cryptographic hash UID iterated from a previous copy of the binary (binary B) if the subsequent binary (binary A) is a modification of the previous binary (binary B);
insertion of the binary's cryptographic hash UID in the block-chain of choice;
establishment and formalization of the method of cryptographic hash UID interaction in the event of binary modification in order to preserve an audit trail of modification;
retrieval of cryptographic hash UID from a block-chain and comparison to a chosen binary UID;
